(19) United States
(12) Patent Application Publication
(10) Pub. No.: US 2026/0170458 A1
(43) Pub. Date: Jun. 18, 2026

(54) System and Method for AI-Driven Patent Infringement Analysis and Prior Art Review of Marketed Products

(71) Applicant: Alexander Davis, Oxnard, CA (US)

(72) Inventor: Alexander Davis, Oxnard, CA (US)

(21) Appl. No.: 18/983,453

(22) Filed: Dec. 17, 2024

(51) Int. Cl. G06Q 10/10; G06F 16/93; G06Q 50/18

(52) U.S. Cl. CPC G06Q 10/10; G06F 16/93; G06Q 50/184; G06F 2216/11

(57) ABSTRACT

An advanced system and method for conducting automated patent infringement analysis and prior art review are disclosed. The system utilizes artificial intelligence (AI) technologies, including machine learning, natural language processing, and computer vision, to evaluate target products against existing patents and prior art references. The invention features a data ingestion module capable of processing patent documents, including design patent drawings and utility claim texts, and a machine learning model trained to identify patterns indicative of patent infringement. Additionally, the system includes a novelty detection module that benchmarks product attributes against prior art to assess innovation. Users interact with the system through a secure interface to input product data and receive comprehensive analysis reports, which detail infringement risks, similarity scores, and novelty assessments. By automating traditionally manual processes, the invention reduces the time and cost of intellectual property analysis while increasing accuracy and scalability.

### BACKGROUND OF THE INVENTION

### Field of Invention

The present invention pertains to the domain of intellectual property law and technological systems, more specifically to the development and implementation of automated methodologies and systems for conducting patent infringement analysis and prior art reviews. The invention is directed toward utilizing artificial intelligence, including machine learning algorithms, to systematically evaluate commercialized products against existing patents to ascertain potential infringement, and to analyze the novelty of such products in relation to prior art. This field of invention addresses critical challenges within patent portfolio management, litigation strategy formulation, and compliance with intellectual property regulations.

### BRIEF SUMMARY OF THE INVENTION

The present invention provides a novel system and method for conducting automated patent infringement analysis and prior art review utilizing advanced artificial intelligence (AI) technologies. The invention encompasses a framework wherein patent documents, including design patent drawings and utility claim texts, are ingested and processed. During an initial training phase, a machine learning model is trained using datasets of known infringing products, enabling the system to identify infringement patterns and novelty indicators with precision.

Subsequently, the trained AI model evaluates target products to determine their potential infringement of existing patents and assesses their novelty in light of prior art. This invention significantly enhances the efficiency, accuracy, and scalability of patent analysis, reducing reliance on manual examination and expert interpretation while maintaining high reliability. The invention is particularly suited for use in intellectual property law firms, corporate legal departments, and entities involved in patent enforcement or defense. It addresses existing gaps in patent analysis methodologies by introducing a robust, data-driven approach to ensure legal compliance and protect intellectual property rights.

### BRIEF DESCRIPTION OF THE FIGURES

FIG. 1: The process encompasses a systematic sequence of steps designed to analyze target products for potential patent infringement and assess their novelty, leveraging AI-powered tools to deliver detailed, actionable reports to users.

### DETAILED DESCRIPTION

The invention is an advanced, AI-driven system designed to automate and optimize the processes of patent infringement detection and prior art review. This system operates by integrating cutting-edge artificial intelligence techniques, including machine learning, natural language processing (NLP), and computer vision, to address the growing complexities of intellectual property analysis. At its core, the system is built to ingest, process, and analyze various forms of patent-related data, such as detailed design patent drawings, utility claim texts, and associated prior art references. The data ingestion process supports a wide range of file formats to ensure compatibility with global patent repositories and corporate intellectual property databases.

The invention begins its operation with a data preparation phase, where raw patent documents and product data are cleansed, structured, and organized into a format suitable for machine learning algorithms. During this phase, the system leverages AI-based tools to extract and categorize textual and visual information. For instance, it uses NLP to analyze claim language, technical specifications, and descriptions, while employing computer vision algorithms to interpret graphical elements like drawings and schematics. This information is then indexed and cross-referenced, forming a comprehensive database that acts as the foundation for subsequent analysis.

The second phase of the system involves a robust machine learning training process. Here, the system is exposed to datasets containing historical examples of known infringing products and their corresponding patents. This training allows the machine learning model to identify patterns of infringement, such as functional overlaps, structural similarities, or design redundancies. The system is also trained to evaluate novelty by comparing product attributes against a curated repository of prior art references, ensuring it can distinguish innovative features from pre-existing ideas with high accuracy. Importantly, the model is adaptive, meaning it continues to learn and improve as new data is added, ensuring its relevance in dynamic technological landscapes.

In practical use, the system is accessed through a secure, user-friendly interface that accommodates various types of users, including intellectual property lawyers, corporate legal teams, patent examiners, and even individual inventors. Users can upload target product data—such as 3D CAD files, product descriptions, or marketing materials—directly into the system. The uploaded data is immediately processed through the trained model, which performs a comprehensive analysis to identify potential infringement or novelty concerns. Results are delivered in a detailed report, which includes similarity scores, highlighted areas of potential conflict, and a list of relevant prior art references. For visual elements, the system generates annotated comparisons, highlighting overlapping design features or structural components.

One of the unique features of the invention is its application versatility. It can be utilized at multiple stages of the product lifecycle, from initial concept development to post-market monitoring. During the design phase, the system can be used by R&D teams to ensure that proposed designs are free from potential infringement risks. At the commercialization stage, it provides corporations with a tool to assess the competitive landscape, identifying potential threats from competitors'patents. In legal disputes, the system serves as an invaluable asset for patent litigation teams, offering evidence-based insights into infringement claims or defenses.

The motivation for adopting this invention is multifaceted. Companies operating in industries with dense patent portfolios, such as pharmaceuticals, consumer electronics, and automotive technologies, can benefit from the system's ability to drastically reduce the time and cost associated with manual patent analysis. By automating complex evaluations, the invention enables organizations to shift resources to more strategic activities, such as innovation and market expansion. Additionally, its precision and scalability make it a compelling choice for law firms handling large volumes of patent cases or for startups seeking affordable solutions to safeguard their intellectual property.

The invention is commercially attractive due to its modular architecture and ability to integrate seamlessly with existing patent management systems and legal databases. It offers subscription-based access, making it financially accessible to organizations of varying sizes. Furthermore, the system ensures data privacy and confidentiality by employing state-of-the-art encryption and secure cloud storage solutions, critical for users working in regulated industries.

In summary, the invention transforms the landscape of patent analysis by providing an efficient, reliable, and scalable solution for identifying infringement risks and evaluating novelty. Its adoption empowers users to make informed decisions, mitigate legal risks, and uphold intellectual property rights with confidence and precision. This system is poised to become an indispensable tool for stakeholders in intellectual property management and innovation-driven industries.

The invention also integrates an advanced patent development and human workflow optimization module. This module allows users to harness artificial intelligence to proactively identify patentable concepts based on data inputs such as product roadmaps, R&D documentation, and market trends. By analyzing these inputs, the system generates initial draft patent applications, including claims, abstracts, and detailed descriptions. This drafting process leverages the system's trained models to align the proposed patents with legal standards and industry-specific requirements.

Once the AI-generated patent draft is complete, it enters a human review workflow where legal professionals, inventors, or stakeholders can assess, refine, and validate the content. The system provides a collaborative interface for this purpose, enabling reviewers to make edits, annotate drafts, and provide feedback directly within the platform. Importantly, the system incorporates a machine learning feedback mechanism to continuously improve its patent drafting capabilities. It learns from human input, refining its understanding of technical nuances, legal phrasing, and user preferences to generate increasingly precise and tailored drafts over time.

This enhancement not only streamlines the patent drafting process but also reduces the cognitive and administrative burden on human users. By integrating patent development with automated workflow management, the system facilitates a closed-loop cycle of invention analysis, documentation, and iterative improvement. The result is a comprehensive platform that accelerates the innovation process, ensuring intellectual property protection is proactive, efficient, and aligned with organizational strategies.

Below is the implementation of the backend code using Python and Flask. It includes key functionalities such as data ingestion, product analysis for infringement risks, and novelty assessment.
Backend Code: Python with Flask
Install Required Libraries
Run the following to install dependencies:
pip install flask flask-restful pandas numpy scikit-learn tensorflow opencv-python
Full Backend Code
from flask import Flask, request, jsonify
import pandas as pd
import numpy as np
from sklearn. ensemble import RandomForestClassifier
import joblib
app=Flask(__name__)
#Load or initialize the machine learning model
def load_model():
   #Example model; replace with a trained model
   model =RandomForestClassifier( )
   return model
#Global model instance
model =load_model( )
#Route to ingest and preprocess data
@app.route(‘/ingest’, methods=[‘POST’])
def ingest_data( ):
   “”“
   Endpoint to upload and preprocess patent-related data.
   “”“
   if ‘file’ not in request. files:
   return jsonify({“error”: “No file uploaded”}), 400
   file=request. files[‘file’]
   try:
      #Assuming CSV format for patent data
      df=pd.read_csv(file)
      #Example preprocessing step: Fill missing values
      df. fillna(“ ”, inplace=True)
      #Save or process as needed
      return jsonify({“message”: “Data ingested successfully”, “rows”: len(df)})
   except Exception as e:
      return jsonify({“error”: str(e)}), 500
#Route to analyze products for infringement risks
@app.route(‘/analyze’, methods=[‘POST’])
def analyze_product( ):
   “”“
      Endpoint to analyze a product for patent infringement risks.
      “”“
      data=request.json
      if not data or “features” not in data:
         return jsonify({“error”: “Invalid input”}), 400
      try:
         features=np.array(data[“features”]).reshape(1, −1)
         prediction=model.predict(features) #Replace with your model's prediction logic
   return jsonify({“infringement_risk”: bool(prediction[0])})
except Exception as e:
   return jsonify({“error”: str(e)}), 500
#Route to assess novelty
@app.route(‘/novelty’, methods=[‘POST’])
def check_novelty( ):
   “”“
   Endpoint to evaluate the novelty of a product.
   “”“
   data=request.json
   if not data or “features” not in data:
      return jsonify({“error”: “Invalid input”}), 400
   try:
      #Placeholder logic for novelty score
      novelty_score=np.random.rand( )
      return jsonify({“novelty_score”: novelty_score})
   except Exception as e:
      return jsonify({“error”: str(e)}), 500
if __name__==‘__main__’:
   app.run(debug=True)

### Explanation of Code Components

### 1. Routes:

/ingest: Handles data uploads (CSV format) for patent-related documents.
/analyze: Accepts product features as input and evaluates infringement risks using a preloaded machine learning model.
/novelty: Computes a placeholder novelty score for the product based on features.

### 2. Model:

Uses a simple RandomForestClassifier as a placeholder. Replace this with your actual machine learning model, loaded from a saved file (e.g., using joblib.load( )).

### 3. Error Handling:

Returns appropriate HTTP error codes for missing files or invalid input.

### 4. Data Preprocessing:

The ingest_data route demonstrates basic data handling and preprocessing, which can be expanded with domain-specific logic.

### DETAILED DESCRIPTION OF FIGURES

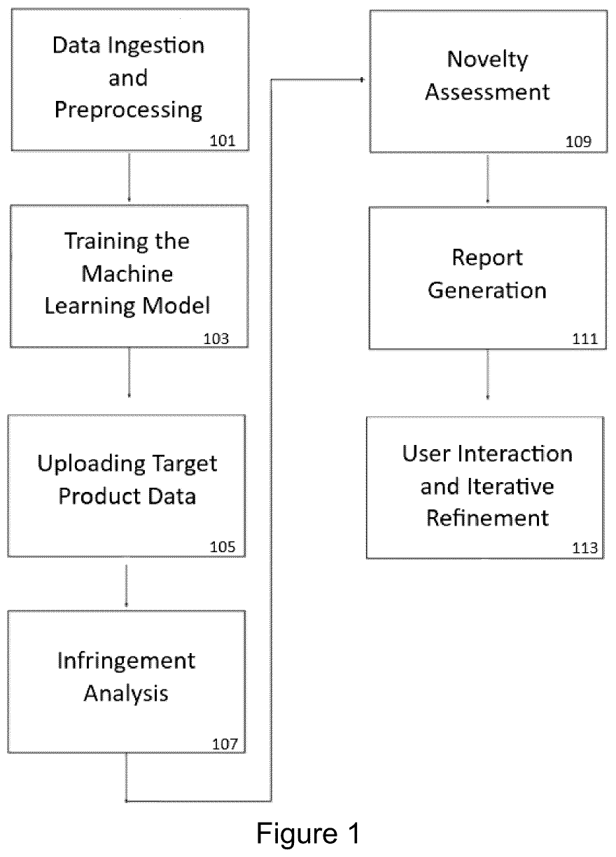

FIG. 1.101—Data Ingestion and Preprocessing—The first step involves the collection and ingestion of patent-related documents, including design patent drawings, utility claim texts, and prior art references. These documents are parsed using natural language processing (NLP) to extract textual elements and computer vision algorithms to interpret graphical data. All data is then standardized, indexed, and stored in a structured database for efficient access during subsequent analysis.

FIG. 1.103—Training the Machine Learning Model—A robust training process follows, during which a machine learning model is exposed to datasets containing known infringing products and their associated patents. The model is trained to recognize infringement patterns, structural similarities, and functional overlaps, and it learns to identify novel features by comparing data against curated prior art repositories. The training phase ensures the model's predictive accuracy and adaptability to evolving patent landscapes.

After training, the machine learning categorization engine processes the patent-related data using pre-trained models trained on datasets of patents and infringing and non-infringing products. It comprises an application-specific integrated circuit (ASIC) for an artificial neural network connected to the computer memory device, the ASIC comprising: a plurality of neurons organized in an array, wherein each neuron comprises a register, a processing element and at least one input, and a plurality of synaptic circuits, each synaptic circuit including a memory for storing a synaptic weight, wherein each neuron is connected to at least one other neuron via one of the plurality of synaptic circuits, wherein the array is configured to analyze said patent-related data using machine learning algorithms trained on historical datasets regarding which products were found to infringe, wherein the AI/ML categorization engine makes a prediction regarding infringement.

FIG. 1.105—Uploading Target Product Data—In this step, users input product-related data into the system through a secure interface. This data may include textual descriptions, 3D CAD files, marketing materials, or any other relevant documentation. The system preprocesses the input data, aligning it with the format and structure of the ingested patent database to facilitate precise comparisons.

FIG. 1.107—Infringement Analysis—The processed product data is then analyzed against the indexed patent database using the trained machine learning model. The analysis identifies potential infringement risks by detecting similarities in design, functionality, or claims between the target product and existing patents. The system highlights specific elements of the product that may overlap with protected features.

FIG. 1.109—Novelty Assessment—Simultaneously, the system evaluates the novelty of the target product by benchmarking its attributes against prior art references. The novelty assessment identifies whether the product introduces innovative elements or replicates known features, providing a quantitative score to indicate the likelihood of novelty.

FIG. 1.111—Report Generation—After completing the analysis, the system generates a detailed report that outlines the findings. The report includes a summary of infringement risks, a list of relevant prior art, similarity scores, and visual or textual annotations highlighting key points of comparison. These reports can be exported in various formats for legal documentation or strategic review.

FIG. 1.113—User Interaction and Iterative Refinement—Finally, users review the results through an interactive interface, allowing for iterative refinement of the analysis. Users can adjust parameters such as jurisdiction, patent class, or feature prioritization to tailor the results to specific needs. Feedback from users further enhances the system's learning and predictive capabilities for future analyses.

What is claimed is:

1. A system for automated patent infringement analysis and prior art review, comprising:
a. a data ingestion module configured to process patent-related documents, including design patent drawings, utility claim texts, and prior art references;
b. a machine learning model trained to identify patterns of patent infringement based on datasets of known infringing products and associated patent documentation;
c. a novelty detection module integrated with the machine learning model, configured to compare attributes of target products against a database of prior art references to assess novelty;
d. a user interface enabling users to input product data and review analysis results, including similarity scores, infringement indicators, and prior art comparisons;
e. a reporting engine configured to generate detailed reports that highlight potential infringement risks and assess the novelty of the analyzed product.

2. The system of claim 1, wherein the data ingestion module further comprises:
a. a natural language processing (NLP) submodule configured to extract and analyze claim language, technical specifications, and textual descriptions;
b. a computer vision submodule configured to interpret and analyze graphical elements, including design patent drawings and schematics.

3. The system of claim 1, wherein the machine learning model is configured to:
a. continuously update and improve its predictive accuracy through adaptive learning as new data is introduced;
b. identify structural, functional, and design similarities between target products and existing patents.

4. The system of claim 1, wherein the novelty detection module is configured to:
a. compare technical and design features of target products against prior art references stored in a curated repository;
b. generate a quantitative novelty score representing the likelihood of innovation relative to prior art.

5. The system of claim 1, wherein the user interface further comprises:
a. an interactive visualization tool for displaying annotated comparisons between target products and existing patents;
b. adjustable parameters allowing users to refine analysis criteria, including specific patent classes, jurisdictions, or technological domains.

6. The system of claim 1, wherein the reporting engine is configured to:
a. generate reports in various formats, including text-based summaries, visual annotations, and exportable files compatible with legal documentation systems;
b. highlight specific claims, drawings, or features contributing to potential infringement or lack of novelty.

7. A method for conducting automated patent infringement analysis and prior art review, comprising the steps of:
a. ingesting and preprocessing patent-related documents and product data through a data ingestion module;
b. training a machine learning model using datasets of known infringing products and their corresponding patent documentation;
c. evaluating a target product by comparing its attributes against a patent database to identify potential infringement;
d. assessing the novelty of the target product by benchmarking its attributes against prior art references;
e. generating a detailed report highlighting infringement risks and novelty assessments, accessible through a user interface.

8. The method of claim 7, further comprising the step of:
a. enabling users to adjust analysis parameters, including jurisdictional scope, claim language specificity, and feature prioritization, through an interactive user interface.

9. The method of claim 7, wherein the step of evaluating the target product further comprises:
a. utilizing natural language processing to compare textual elements of the target product with patent claims;
b. employing computer vision to detect design similarities between the target product and patent drawings.

10. The method of claim 7, wherein the step of generating a detailed report further comprises:
a. providing recommendations for design or functional modifications to mitigate infringement risks;
b. categorizing findings based on the likelihood and severity of potential
infringement or novelty concerns.

11. The system of claim 1, further configured to integrate with third-party patent management systems or legal databases to enhance its functionality and scope.

12. The system of claim 1, wherein the data ingestion module supports multiple file formats, including text, image, CAD, and 3D modeling files, to accommodate diverse product and patent data types.

13. The system of claim 1, further comprising a patent development and workflow optimization module configured to:
a. analyze input data, including product roadmaps, research documentation, and market trends, to identify patentable concepts;
b. automatically generate draft patent applications, including claims, abstracts, and detailed descriptions, based on the analyzed data;
c. provide a collaborative interface enabling human reviewers to refine, annotate, and validate the AI-generated drafts;
d. incorporate a feedback mechanism to continuously improve the accuracy, precision, and relevance of the patent drafts based on human edits and annotations.

14. An application-specific integrated circuit (ASIC) for an artificial neural network, the ASIC comprising: a plurality of neurons organized in an array, wherein each neuron comprises a register, a processing element and at least one product data input, and a plurality of synaptic circuits, each synaptic circuit including a memory for storing a synaptic weight, wherein each neuron is connected to at least one other neuron via one of the plurality of synaptic circuits, wherein the array contains historical data comprises a patent document and one or more infringing products and one or more non-infringing products, and wherein the plurality of synaptic circuit make a prediction regarding infringement for the product data input.
